(19) United States
(12) Patent Application Publication
(10) Pub. No.: US 2018/0196494 A1
(43) Pub. Date: Jul. 12, 2018

(54) POWER SUPPLY FOR SUPPLYING POWER TO A WIRED DIGITAL INFORMATION BUS SYSTEM

(71) Applicant: Lunatone Industrielle Elektronik GmbH, Wien/Vienna (AT)

(72) Inventor: Alexander Mair, Breitstetten (AT)

(73) Assignee: Lunatone Industrielle Elektronik GmbH, Wien/Vienna (AT)

(21) Appl. No.: 15/740,393

(22) PCT Filed: May 10, 2016
(86) PCT No.: PCT/AT2016/050136

§ 371 Date: Dec. 28, 2017

(30) Foreign Application Priority Data
Jun. 29, 2015 (AT) A 50565/2015

(51) Int. Cl. G06F 1/32; H02H 7/20; G06F 1/26; H02H 9/02; H01G 11/16

(52) U.S. Cl. CPC G06F 1/3253; H02H 7/20; H01G 11/16; H02H 9/02; G06F 1/263

(57) ABSTRACT

A power supply for supplying power to a digital information bus system via a voltage output, wherein the power supply includes a voltage input supplied with a first voltage and a current-limiting circuit connected between the first voltage input and the voltage output, wherein the power supply also includes a control circuit for controlling a first switching element, which is arranged between the first voltage input and the current-limiting circuit, for switchably connecting the first voltage input to the current-limiting circuit, and a second voltage input supplied with a second voltage.

The invention relates to a power supply for supplying power to a wired digital information bus system by means of a voltage output, wherein the power supply comprises:
a first voltage input supplied with a first voltage, and
a current-limiting circuit connected between the first voltage input and the voltage output.

Wired bus systems that are used for distributing information between various bus subscribers, in which the bus is supplied with a defined voltage by means of a voltage source, wherein a current-limiting circuit connected between the voltage source and the subscribers ensures that a short circuit of the bus leads only to current of limited magnitude, are known from the prior art. The individual subscribers communicate with one another in that they can short circuit the bus selectively, for example within time intervals associated with the subscribers, whereby the voltage level of the bus drops from a first level to a second, lower voltage level. Either a “low” or “high” state is associated with the voltage levels respectively, wherein the individual subscribers can reproduce/detect the sequence of these states in the form of digital information with the aid of a coding. The voltage difference between the first and the second voltage level drops for a large part at the current-limiting circuit, in which electrical energy is converted into thermal energy in the form of lost heat in accordance with the product of voltage, current and length of time at the current-limiting circuit.

The lost heat leads to a thermal loading of the current-limiting circuit and in addition limits the electrical efficiency of the power supply and of a bus system supplied by the power supply.

The object of the invention is therefore to create a power supply which overcomes these disadvantages easily without great additional cost. This object is achieved with a power supply of the kind described in the introduction, which, in accordance with the invention, comprises a control circuit for controlling a first switching element arranged between the first voltage input and the current-limiting circuit for switchably connecting the first voltage input to the current-limiting circuit, and a second voltage input supplied with a second voltage, wherein the control circuit is designed to detect the voltage at the voltage output and, in the event that a determinable first threshold voltage has been fallen below, to separate the connection of the first voltage input to the current-limiting circuit by control of the first switching element and to re-establish said connection in the event that a second threshold value is exceeded, wherein the second voltage input is designed to supply the current-limiting circuit with the second voltage during the period of separation by the first switching element, wherein the second voltage is lower than the first voltage. By replacing the first voltage by a lower second voltage, the power loss realised in the current-limiting circuit can be significantly reduced during the time for which a subscriber short circuits the bus (or the signal line of the bus) in order to signal the “low” state. In addition, if desired, the short-circuit current can also be reduced, whereby the losses at all ohmic resistors arranged in the electrical circuit can be reduced in accordance with the relationship I²R.

The voltage can be detected at the voltage output by the control circuit by means of a direct or indirect measurement (for example by current measurement). The term “power supply” within the sense of the present invention is not limited to an electrical circuit arranged within a housing, but relates rather generally to a power supply unit, which can also be constructed by all means in a modular manner. Relative statements with regard to individual electrical parts, circuits or components, such as “between part A and point B”, unless indicated otherwise, do not relate to a physical arrangement, and instead relate to the circuit topology described in the particular context.

The second voltage input makes it possible to supply the current-limiting circuit with the second voltage during the period of separation by the first switching element in order to maintain a minimum supply voltage. This minimum supply voltage makes it possible that the voltage level of the bus system, upon termination of a particular short circuit, rises again above the second threshold value, so that the control circuit identifies the change to the “high” state, and connects through the first voltage input to the current-limiting circuit again and supplies the bus with the higher first voltage. The first voltage for example can be used for efficient power supply of the individual bus subscribers.

An information bus system, such as the digital light bus “DALI”, in the sense of the present invention comprises both a communication bus and bus subscribers.

It can be particularly favourable if a feed point is disposed between the first switching element and the current-limiting circuit and if the second voltage input is connected to the feed point by means of an electrical component or circuit that allows current to pass in the direction of the feed point and blocks current in the opposite direction. Energy flows from the feed point to the voltage input can thus be avoided in a simple way.

In a particularly simple variant of the invention it can be provided that the blocking component is a diode.

Alternatively, it could also be provided that the blocking component is a second switching element connected inversely to the first switching element, wherein the first and the second switching element are preferably transistor switches.

In order to achieve a particularly simple implementation of the invention, it can be provided that the first and second threshold value are of equal magnitude. The two threshold values can thus be replaced by a single threshold value. Here, it can be particularly favourable if the control voltage comprises a voltage comparator which is configured to compare the voltage output with the threshold value.

Alternatively, it is also possible to determine threshold values that are different from one another.

In particular, it can be provided that the second voltage is of such a magnitude that at least the minimum voltage, corresponding to the lower limit value of a bus voltage of a digital information bus system associated with the power supply, with which the logic bus state “high” is associated, is applied at the feed point. In addition, it can be provided that the second voltage is at least 5%, preferably at least 20% higher than the minimum voltage.

It can be particularly favourable if the second voltage is at most 70% of the first voltage, preferably at most 50%, particularly preferably at most 30% of the first voltage. The lower the second voltage is selected to be, the more energy can be saved, wherein the function of the bus must still be ensured.

In particular, it can be provided that the power supply comprises a transformer, wherein the first and the second voltage are provided by one or two secondary windings of the transformer. If the first and the second voltage are to be made available from a common secondary winding, the first voltage could be tapped at the ends of the common secondary windings and the second voltage could be tapped at a tapping point between the ends. Alternatively, the first and the second voltage can each be made available by means of their own, separate secondary winding.

In particular, it can be provided that the power supply comprises a step-down converter, wherein the second voltage is formed from the first voltage with the aid of the step-down converter.

Alternatively, it can be provided that the power supply comprises a step-up converter, wherein the first voltage is formed from the second voltage with the aid of the step-up converter.

In order to stabilise the particular voltage, it can be provided that the power supply comprises an energy storage device, preferably an accumulator or a supercapacitor, by means of which the first voltage and/or the second voltage is supported.

In order to limit the losses in the current-limiting circuit and in other involved components in the event of an error on account of which the bus is short-circuited for a relatively long period of time, it can be favourable if the control circuit is configured:—to detect the period of time for which the voltage output continuously falls below the first threshold value,—to compare the period of time with a limit value, and—if the limit value is exceeded, to trigger a separation or disconnection of the second voltage, wherein the limit value is between 10 and 5000 ms.

In particular, it should be provided that the voltage output is free from capacitors connected in parallel with the voltage output, i.e. has no capacitors connected in parallel. An extremely low output capacitance is desirable. Otherwise, the current Ib would only be able to be limited by means of the current-limiting circuit, whereby the bus subscribers would have to transfer higher short-circuit currents and in addition the dynamics of the bus system could deteriorate.

The invention will be explained in greater detail hereinafter with reference to an exemplary and non-limiting embodiment illustrated in the figures in which,

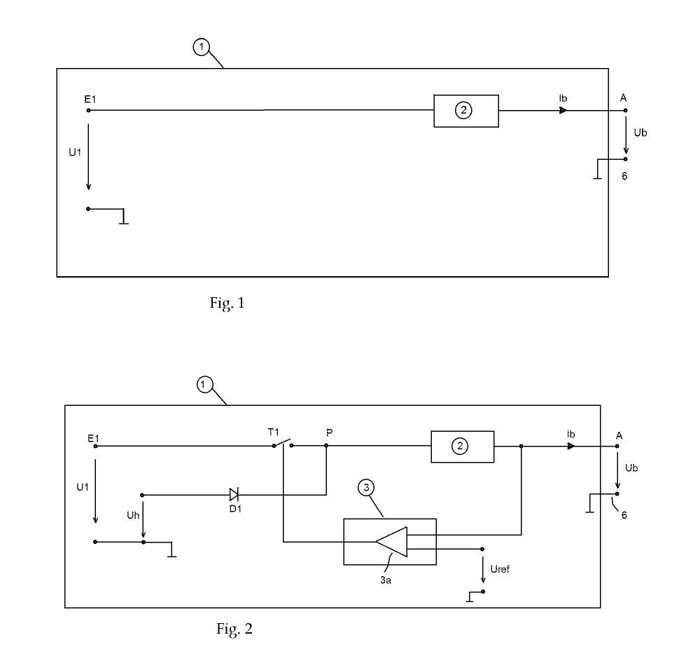

FIG. 1 shows a schematic illustration of a power supply according to the prior art,

FIG. 2 shows a schematic illustration of an embodiment of a power supply according to the invention,

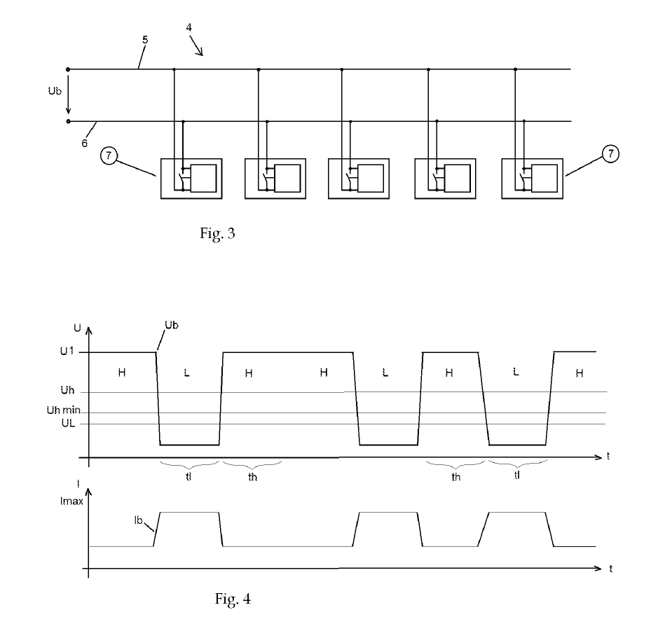

FIG. 3 shows a depiction of an information bus system, and

FIG. 4 shows an exemplary depiction of a progression over time of the voltage level and current profile of the signal line of an information bus system supplied by the power supply according to the invention.

Unless indicated otherwise, in the following figures like reference signs denote like features.

FIG. 1 shows a schematic depiction of a power supply 1 according to the prior art. The power supply 1 has a first voltage input E1, which is supplied with a first voltage U1. The power supply 1 additionally has a voltage output A or an output voltage Ub applied at said output, with which for example the digital information bus system 4 shown in FIG. 3, comprising a signal line 5, a ground line 6, and a plurality of bus subscribers 7 connected between the signal line 5 and the ground line 6, is supplied. The output voltage Ub is applied at the signal line 5 and is therefore also referred to hereinafter as a bus voltage. The subscribers 7 are designed to exchange information by connecting the signal line 5 to the ground line 6 (or another common reference line) or disconnecting said lines, so that the voltage level of the output voltage Ub changes between two states. The subscribers 7 can monitor the output voltage Ub and can register an L bit (low bit) in the event that a certain voltage level UL is fallen below and can register an H bit (high bit) in the event that a voltage level Uh,min is exceeded (depending on the coding, these states can be associated with the signals “logical zero” and “logical one”.

In order to limit the current Ib depicted in FIG. 1, power supplies according to the prior art comprise a current-limiting circuit 2, which in the simplest case consists of an ohmic resistor. Each bus subscriber 7 can transmit information to the other subscribers 7 by sequential short-circuiting of the bus. The bus subscribers 7 can be configured, during the sending of information, to also read this information themselves and thus identify a potential fault and to repeat the output at another moment in time.

The current-limiting circuit 2 ensures that the bus subscribers 7, when transmitting data, only have to short circuit a defined current. In this regard, in contrast to other conventional power supplies, there is no need to provide a capacitor at the voltage output A, and therefore a current higher than that made available by the current-limiting circuit 2 can at no point flow across the signal line 5.

FIG. 2 shows a schematic depiction of an embodiment of a power supply 1 according to the invention for supplying power to the digital information bus system 4 via a voltage output A or an output voltage Ub applied at said output, wherein the power supply 1 comprises:
a first voltage input E1 supplied with a first voltage U1, and
a current-limiting circuit 2 connected between the first voltage input E1 and the voltage output Ub. In contrast to the power supplies according to the prior art, the power supply 1 according to the invention also comprises a control circuit 3 for controlling a first switching element T1 arranged between the first voltage input E1 and the current-limiting circuit 2 for switchably connecting the first voltage input E1 to the current-limiting circuit 2, and a second voltage input E2 supplied with a second voltage E2, wherein the control circuit 3 is designed to detect the voltage at the voltage output Ub and to separate the connection of the voltage input E1 to the current-limiting circuit 2 by control of the first switching element T1 in the event that a determinable first threshold value Us1 is fallen below (for example Us1≤Uh,min) and to re-establish said connection in the event that a second threshold value Us2 is exceeded (for example Us2≥Uh,min). The second voltage input E2 is designed to supply the current-limiting circuit 2 with the second voltage Uh during the period of separation by the first switching element, T1 wherein the second voltage U1 is lower than the first voltage Uh. The bus voltage is thus decreased during the period of an L bit and the power loss realised at the current-limiting circuit 2 is reduced.

A feed point P, at which at least the minimum voltage Uh,min from which an H bit can be registered is applied, is disposed between the first switching element T1 and the current-limiting circuit 2. This is expedient since a termination of a short circuit by a subscriber 7 reduces the bus current Ib, so that the minimum voltage Uh,min is applied at the voltage output A and signals the change from an L bit to an H bit, which is detected by the control circuit 3, which then connects the first voltage U1 to the current-limiting circuit 2 via the first switching element T1.

The second voltage input E2 is connected in the shown exemplary embodiment to the feed point P via a diode D1 that allows current to flow in the direction of the feed point P and blocks current in the opposite direction (in general, any electrical component or circuits known to a person skilled in the art can be used), said diode preventing a return flow of power from the feed point P to the second voltage input E2.

The control circuit 3 in the shown embodiment comprises a voltage comparator 3a, which is configured to compare the voltage output A or the output voltage Ub with a threshold value Uref and which, depending on the result of said comparison, opens or closes the switching element T1, wherein the following is true in the shown exemplary embodiment: Uref=Us1=Us2.

FIG. 4 shows an exemplary depiction of a progression over time of the voltage level and of the current profile in the signal line 5 of an information bus system 4 supplied by the power supply 1 according to the invention. In this figure, limit values for the voltage levels UL and Uh,min already discussed are depicted, wherein the voltage level of the second voltage Uh is sufficiently distanced from the minimum voltage Uh,min.

In the L phases (that is to say the period of time within which an L bit is applied at the bus; short-circuited bus), the first voltage U1 is no longer applied at the bus subscribers 3, and instead drops at the current-limiting circuit 2. In the case of a very active bus, which is supplied by a conventional power supply, a large part of the available power in the current-limiting circuit 2 is therefore converted into heat.

This energy loss per bit can be calculated by the formula Ib×Ub×tb.

By means of the power supply 1 according to the invention, the voltage U1 can be separated from the current-limiting circuit 2 and replaced by the second voltage Uh during each L phase with the aid of the switch T1.

If Uh for example is only a third of U1, the power loss in the current-limiting circuit 2 thus also reduces by at least a third of the losses otherwise occurring. In order to minimise the energy losses of the power supply 1 and of the information bus system 4 in the event of a fault in which the signal line 5 is permanently short-circuited, it can be provided that the control circuit 3 is configured
to detect the period of time for which the voltage output Ub continuously falls below the first threshold value Us1,
to compare the period of time with a limit value, and
in the event that the limit value is exceeded, to initiate a separation or disconnection of the second voltage Uh from the feed point P,
   wherein the limit value is between 10 and 5000 ms.

In view of this teaching, a person skilled in the art is able to arrive at other embodiments of the invention (not shown), without exercising inventive skill. The invention is therefore not limited to the shown embodiment. Individual aspects of the invention or of the embodiment can also be selected and combined with one another. What are essential are the concepts forming the basis of the invention, which can be put into practice by a person skilled in the art in a variety of ways in the knowledge of this description, yet remain unchanged in essence.

1. A power supply for supplying power to a digital information bus system via a voltage output, wherein the power supply comprises:
a voltage input supplied with a first voltage, and
a current-limiting circuit connected between the first voltage input and the voltage output,
characterised by
a control circuit for controlling a first switching element, which is arranged between the first voltage input and the current-limiting circuit, for switchably connecting the first voltage input to the current-limiting circuit, and
a second voltage input supplied with a second voltage,
wherein the control circuit is designed to detect the output voltage at the voltage output and to separate the connection of the first voltage input to the current-limiting circuit by control of the first switching element in the event that a determinable first threshold value is fallen below and to re-establish said connection in the event that a second threshold value is exceeded,
wherein the second voltage input is configured to supply the current-limiting circuit with the second voltage during the period of separation by the first switching element wherein the second voltage is lower than the first voltage.

2. The power supply according to claim 1, characterised in that a feed point is disposed between the first switching element and the current-limiting circuit, and the second voltage input is connected to the feed point via an electrical component or circuit that allows current to flow in the direction of the feed point and blocks current in the opposite direction.

3. The power supply to claim 2, characterised in that the blocking component is a diode.

4. The power supply according to claim 2, characterised in that the blocking component is a second switching element connected inversely in relation to the first switching element, wherein the first and the second switching element are transistor switches.

5. The power supply according to claim 1, characterised in that the first and the second threshold values and are of equal magnitude.

6. The power supply according to claim 5, characterised in that the control circuit comprises a voltage comparator, which is configured to compare the voltage output with the threshold value.

7. The power supply according to claim 6, characterised in that the second voltage is of such a magnitude that at least a minimum voltage, corresponding to a lower limit value of a bus voltage of a digital information bus system associated with the power supply, with which a logic bus state “high” is associated, is applied at the feed point.

8. The power supply according to claim 7, characterised in that the second voltage is at least 5% higher than the minimum voltage.

9. The power supply according to claim 1, characterised in that the second voltage is at most 70% of the first voltage.

10. The power supply according to claim 1, characterised in that the power supply comprises a transformer, wherein the first and the second voltages are provided by at least one secondary winding of the transformer.

11. The power supply according to claim 1, characterised in that the power supply comprises a step-down converter, wherein the second voltage is formed from the first voltage with the aid of the step-down converter.

12. The power supply according to claim 1, characterised in that the power supply comprises a step-up converter, wherein the first voltage is formed from the second voltage with the aid of the step-up converter.

13. The power supply according to claim 1, characterised in that the power supply comprises an energy storage device by which at least one of the first voltage and the second voltage is supported.

14. The power supply according to claim 1, characterised in that the control circuit is configured
to detect a period of time for which the voltage output continuously falls below the first threshold value,
to compare the period of time with a limit value, and
in the event that the limit value is exceeded, to initiate a separation or disconnection of the second voltage,
wherein the limit value is between 10 and 5000 ms.

15. The power supply (1) according to claim 1, characterised in that the voltage output is fee from capacitors connected in parallel with the voltage output.

16. The power supply according to claim 8, wherein the second voltage is at least 20% higher than the minimum voltage.

17. The power supply according to claim 9, wherein the second voltage is at most 50% of the first voltage.

18. The power supply according to claim 17, wherein the second voltage is at most 30% of the first voltage.

19. The power supply according to claim 13, wherein the storage device comprises an accumulator.

20. The power supply according to claim 13, wherein the storage device comprises a supercapacitor.
